(19) United States
(12) Patent Application Publication
(10) Pub. No.: US 2007/0165272 A1
(43) Pub. Date: Jul. 19, 2007

(54) SYSTEM AND METHOD FOR SUBMITTING A PATENT APPLICATION ELECTRONICALLY

(75) Inventors: CHUNG-I LEE, Tu-Cheng (TW); HAI-HONG LIN, Shenzhen (CN); DE-YI XIE, Shenzhen (CN); ZHENG-CAI ZHU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/614,986

(22) Filed: Dec. 22, 2006

(30) Foreign Application Priority Data
Jan. 16, 2006 (CN) 200610033108.6

(51) Int. Cl. G06F 3/12

(52) U.S. Cl. 358/1.15; 358/1.13

(57) ABSTRACT

A system for submitting a patent application electronically is disclosed. The system includes: a file converting module (205) configured for converting a specification and figures of the patent application saved in a local server into an application body extensible (ABX) word file, and converting the ABX word file into an extensible markup language (XML) file and a portable document format (PDF) file; a packing module (206) configured for packing the XML file, the PDF file, and patent details into an application package; and a submitting module (207) configured for submitting the application file package to a remote server located at a designated Patent office. A related method is also disclosed.

### BACKGROUND OF THE INVENTION

1. Field of the Invention

The present invention relates to a system and method for submitting a patent application electronically.

2. Description of Related Art

Patent applications are submitted to a designated patent office. Usually, the patent application is submitted through the post office. However, submitting applications through the post office requires a long time. Furthermore, before submitting the patent application, organizing paper works of the patent application by a corresponding undertaker takes up a lot of time also.

The Internet has provided network users with a mechanism for transferring information through a number of different networked servers. However, there are no publicly known techniques that can submit the patent application via the network and format the patent application automatically.

Therefore, what is needed is a system and method for submitting a patent application electronically, by which the user can format and submit the patent application efficiently.

### SUMMARY OF THE INVENTION

A system for submitting a patent application electronically includes: a file converting module configured for converting a specification and figures of the patent application saved in a local server into an application body extensible (ABX) word file, and converting the ABX word file into an extensible markup language (XML) file and a portable document format (PDF) file; a packing module configured for packing the XML file, the PDF file, and patent details into an application file package; and a submitting module configured for transferring the application file package to a remote server located at a designated patent office.

A related method for submitting a patent application electronically includes the steps of: converting a specification and figures of the patent application saved in a local server into an application body extensible (ABX) word file; converting the ABX word file into an extensible markup language (XML) file and a portable document format (PDF) file; packing the XML file, the PDF file, and patent details into an application file package; and transferring the application file package to a remote server located at a designated patent office.

Other advantages and novel features of the embodiments will be drawn from the following detailed description with reference to the attached drawings.

### BRIEF DESCRIPTION OF THE DRAWINGS

FIG. 1 is a schematic diagram of hardware configuration of a system for submitting a patent application electronically in accordance with a preferred embodiment;

FIG. 2 is a flowchart of a preferred method for submitting a patent application electronically by utilizing the system of FIG. 1; and

FIG. 3 is a flowchart of details of the step of packing the XML file, the PDF file, and patent details to be a file package in FIG. 2.

### DETAILED DESCRIPTION OF THE INVENTION

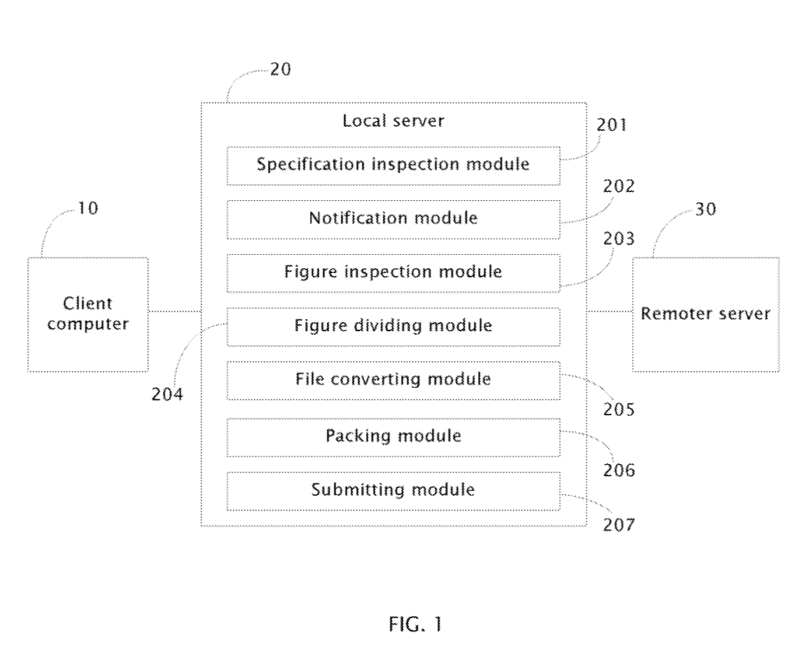

FIG. 1 is a schematic diagram of hardware configuration of a system for submitting a patent application electronically (hereinafter, “the system”) in accordance with a preferred embodiment. The system includes: a client computer 10, a local server 20, and a remote server 30. The client computer 10 is connects to the local server 20 via a local area network (LAN). The local server 20 is connects to the remote server 30 via the Internet.

The client computer 10 may be a personal computer (PC), a personal digital assistant (PDA), or any other computers. In the preferred embodiment, the patent application generally includes a specification and one or more figures. The specification, as referred, includes background, summary, brief description of the drawings, detailed description, claims, and abstract.

Typically, the local server 20 is digitally stored with the patent application and patent details of the patent application, and includes a specification inspection module 201, a notification module 202, a figure inspection module 203, a figure dividing module 204, a file converting module 205, a packing module 206, and a submitting module 207. The local server 20 is configured for submitting the patent application to the remote server 30 electronically. The patent details includes information of: inventors, designated patent attorney or patent agent, foreign priority date, information disclosure statements (IDS), assignee(s), signature of inventors, and so on of the patent application. The remote server 30 may be a server of the United States Patent and Trademark Office (USPTO) or any other designated patent office.

The specification inspection module 201 is configured for analyzing contents and formats of the specification of the patent application, and detecting whether the contents and the formats are in compliance according to the USPTO guidelines. For example, the specification inspection module 201 detects whether the specification includes the summary, the abstract, the claims, and so on.

The notification module 202 is configured for notifying an undertaker of the patent application to revise the specification by sending an E-mail, a text message, or by any other means, if the contents and/or the formats are not in compliance.

The figures inspection module 203 is configured for analyzing the figures of the patent application, and detecting whether there are two or more figures in one page.

The figures dividing module 204 is configured for extracting each of the figure onto separate pages to ensure that each page contains only one figure if there are two or more figures in one page.

The file converting module 205 is configured for converting the specification and the figures of the patent application saved in the local server 20 into an application body extensible (ABX) word file, and converting the ABX word file into an extensible markup language (XML) file and a portable document format (PDF) file. The XML file converted from the ABX word file is a standard format file that also includes the specification and the figures. The PDF file includes four parts (the abstract, the claims, the specification, and the figures) as a backup copy of the patent application.

The packing module 206 is configured for packing the XML file, the PDF file, and the patent details into an application file package. Herein, the packing module 206 downloads the patent details from the local server 20, reads a title of the patent application and the number of the claims from the XML file and the PDF file, and creates xml nodes of the patent details for the XML file. The xml nodes are used for formatting the XML file and include xml nodes of: information of inventors, designated attorney or agent, foreign priority, information disclosure statement (IDS), assignee, signature of inventors, and so on.

The submitting module 207 is configured for transferring the application file package to the remote server 30 via the Internet.

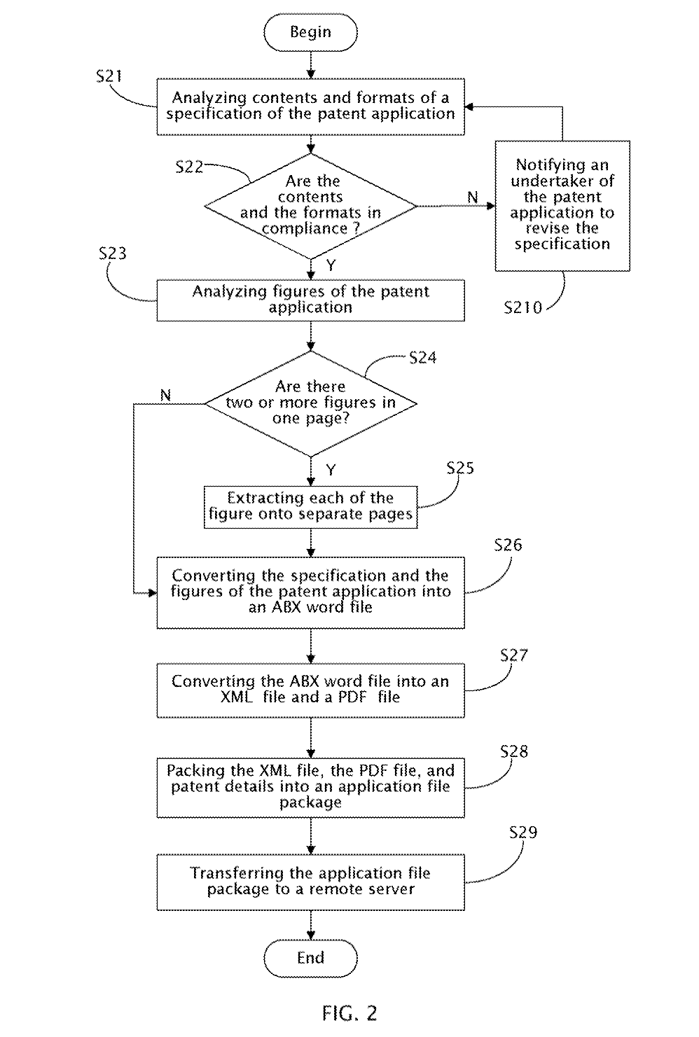

FIG. 2 is a flowchart of a preferred method for submitting a patent application file electronically by utilizing the system of FIG. 1. In step S21, the specification checking module 201 analyzes contents and formats of a specification of a patent application.

In step S22, the specification inspection module 201 analyzes contents and formats and detects whether the contents and the formats are in compliance according to the USPTO guidelines.

If the contents and the formats are in compliance, In step S23, the figures inspection module 203 analyzes figures of the patent application.

In step S24, the figures inspection module 203 detects whether there are two or more figures in one page.

If there are two or more figures in one page, In step S25, the figures dividing module 204 extracts each of the figure onto separate pages to ensure that each page contains only one figure.

In step S26, the file converting module 205 converts the specification and the figures of the patent application saved in the local server 20 into an application body extensible (ABX) word file.

In step S27, the file converting module 205 converts the ABX word file into an extensible markup language (XML) file and a portable document format (PDF) file.

In step S28, the packing module 206 packs the XML file, the PDF file, and patent details into an application file package.

In step S29, the submitting module 207 transfers the application file package to the remote server 30.

Otherwise, if the contents and the formats are not in compliance, In step S210, the noticing module 202 notifies the undertaker of the patent application to revise the specification, and the procedure returns to the step S22.

If in the step S24, if each page contains only one figure, the procedure jumps to the step S26.

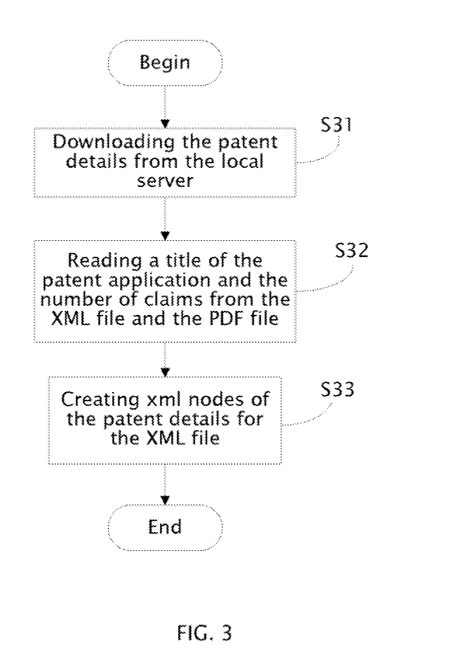

FIG. 3 is a flowchart of the step of packing the XML file, the PDF file, and patent details to be a file package of FIG. 2. In step S31, the packing module 206 downloads the patent details from the local server 20.

In step S32, the packing module 206 reads a title of the patent application and the number of claims, from the XML file and the PDF file.

In step S33, the packing module 206 creates xml nodes of the patent details for the XML file.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for submitting a patent application electronically, the system comprising:
a file converting module configured for converting a specification and figures of the patent application saved in a local server into an application body extensible (ABX) word file, and converting the ABX word file into an extensible markup language (XML) file and a portable document format (PDF) file;
a packing module configured for packing the XML file, the PDF file, and patent details into an application file package; and
a submitting module configured for transferring the application file package to a remote server located at a designated patent office.

2. The system according to claim 1, wherein the patent details are saved in the local server, and comprises information of: inventors, designated patent attorney or patent agent, foreign priority data, information disclosure statements (IDS), assignee(s), and signature of inventors.

3. The system according to claim 1, further comprising:
a specification inspection module configured for analyzing contents and formats of the specification of the patent application, and detecting whether the contents and the formats are in compliance;
a notification module configured for notifying an undertaker of the patent application to revise the specification if the contents and the formats are not in compliance;
a figures inspection module configured for analyzing the figures of the patent application, and detecting whether there are two or more figures in one page; and
a figures dividing module configured for extracting each of the figure onto separate pages to ensure that each page contains only one figure if there are two or more figures in one page.

4. The system according to claim 1, wherein the packing module is further configured for downloading the patent details from the local server, reading a title of the patent application and the number of claims, from the XML file and the PDF file, and creating xml nodes of the patent details for the XML file.

5. A computer-based method for submitting a patent application electronically, the method comprising the steps of:
converting a specification and figures of the patent application saved in a local server into an application body extensible (ABX) word file;
converting the ABX word file into an extensible markup language (XML) file and a portable document format (PDF) file;
packing the XML file, the PDF file, and patent details into an application file package; and
transferring the application file package to a remote server located at a designated patent office.

6. The method according to claim 5, wherein the patent details are saved in the local server, and comprises information of: inventors, designated patent attorney or patent agent, foreign priority data, information disclosure statements (IDS), assignee(s), and signature of inventors.

7. The method according to claim 5, further comprising the steps of:
analyzing contents and formats of the specification of the patent application;
detecting whether the contents and the formats are in compliance;
analyzing the figures of the patent application if the contents and the formats are in compliance;
detecting whether there are two or more figures in one page; and
extracting each of the figure onto separate pages to ensure that each page contains only one figure, if there are two or more figures in one page.

8. The method according to claim 7, further comprising the step of:
notifying an undertaker of the patent application if the contents and the formats are not in compliance.

9. The method according to claim 5, wherein the step of packing the XML file, the PDF file, and patent details to be a file package comprises the steps of:
downloading the patent details from the local server;
reading a title of the patent application and the number of claims, from the XML file and the PDF file; and
creating xml nodes of the patent details for the XML file.
